(19) United States
(12) Patent Application Publication
(10) Pub. No.: US 2025/0106049 A1
(43) Pub. Date: Mar. 27, 2025

(54) BLOCKCHAIN CONTROL SYSTEM, NON-TRANSITORY COMPUTER READABLE MEDIUM STORING BLOCKCHAIN CONTROL PROGRAM, AND BLOCKCHAIN CONTROL METHOD

(71) Applicant: FUJIFILM Business Innovation Corp., Tokyo (JP)

(72) Inventor: Shunsuke KIRYU, Kanagawa (JP)

(73) Assignee: FUJIFILM Business Innovation Corp., Tokyo (JP)

(21) Appl. No.: 18/586,540

(22) Filed: Feb. 26, 2024

(30) Foreign Application Priority Data
Sep. 25, 2023 (JP) 2023-160134

(51) Int. Cl. H04L 9/00

(52) U.S. Cl. CPC H04L 9/50

(57) ABSTRACT

A blockchain control system includes plural devices that each store a blockchain, are communicably connected to each other, and each execute a mining process of adding a new block to the blockchain in cooperation with another device, and a processor, in which each device included in the plural devices outputs process execution/non-execution information indicating whether or not the mining process is executable in the device, and the processor is configured to acquire transaction information that is information included in a block from any of the plural devices, set a mining difficulty that is a difficulty of the mining process regarding the block including the transaction information in accordance with the number of process executable devices that are devices determined that the mining process is executable at a point in time at which the mining process of the block including the transaction information is executed among the plural devices, based on the process execution/non-execution information output by each device, and add the block including the transaction information to the blockchain in a case where a result of the mining process by the process executable device satisfies a condition decided in accordance with the mining difficulty.

### CROSS-REFERENCE TO RELATED APPLICATIONS

This application is based on and claims priority under 35 USC 119 from Japanese Patent Application No. 2023-160134 filed Sep. 25, 2023.

### BACKGROUND

### (i) Technical Field

The present invention relates to a blockchain control system, a non-transitory computer readable medium storing a blockchain control program, and a blockchain control method.

### (ii) Related Art

In the related art, a technique called blockchain has been known. The blockchain has a structure in which data units called blocks including transaction information that is recording target information are connected like a chain. The blockchain is stored in each of a plurality of devices (also referred to as nodes) that can directly communicate with each other. Such a mechanism suppresses tampering with recording target data.

A process of adding a new block to the blockchain is called a mining process. The mining process is executed by each device participating in the blockchain. Generally, a huge amount of calculation is required for the mining process. Then, the number of blocks newly added per predetermined time can be adjusted by adjusting the amount of calculation required for the mining process.

In the related art, a technique related to improvement of the mining process has been proposed. For example, JP2019-106612A discloses a mining device including a first calculation unit that executes various application programs such as a document creation program, a spreadsheet program, or an image processing program, and a second calculation unit that executes a mining process of adding a block to a blockchain, in which the second calculation unit executes the mining process while the first calculation unit executes the application program.

JP2022-546773A discloses that, in a mining pool that executes a mining process of adding a block to a blockchain, each miner participating in the mining pool transmits a report indicating a result of the mining process to a pool master device of the mining pool.

Further, JP2019-101797A discloses a distribution management system for a mining process of adding a block to a blockchain, in which a mining rate, which is a result of the mining process of each user terminal that is a node configuring the blockchain, is managed in a management server, and a reward corresponding to the mining rate is paid to a user.

### SUMMARY

As described above, a huge amount of calculation is required for the mining process, and a plurality of devices participating in the blockchain may cooperate to execute the mining process. In a case where the plurality of devices cooperate to execute the mining process, an increase in a mining time that is a time required for the mining process can be suppressed even in a case where a device having a strong calculation capability is not included in the blockchain.

Here, the device participating in the blockchain may execute a process other than the mining process (referred to as a normal process in the present specification). In a case where the device participating in the blockchain executes the normal process, the mining process may not be executable in the device. Therefore, in a case where the device participating in the blockchain executes the normal process, the calculation capability for the mining process as the entire blockchain may vary depending on whether or not the device executes the normal process, and the mining time may vary.

Aspects of non-limiting embodiments of the present disclosure relate to a blockchain control system, a non-transitory computer readable medium storing a blockchain control program, and a blockchain control method that, in a blockchain in which a plurality of devices cooperate to execute a mining process, suppress a variation in a mining time even in a case where the device participating in the blockchain executes a normal process other than the mining process.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a blockchain control system including a plurality of devices that each store a blockchain, are communicably connected to each other, and each execute a mining process of adding a new block to the blockchain in cooperation with another device, and a processor, in which each device included in the plurality of devices outputs process execution/non-execution information indicating whether or not the mining process is executable in the device, and the processor is configured to acquire transaction information that is information included in a block from any of the plurality of devices, set a mining difficulty that is a difficulty of the mining process regarding the block including the transaction information in accordance with the number of process executable devices that are devices determined that the mining process is executable at a point in time at which the mining process of the block including the transaction information is executed among the plurality of devices, based on the process execution/non-execution information output by each device, and add the block including the transaction information to the blockchain in a case where a result of the mining process by the process executable device satisfies a condition decided in accordance with the mining difficulty.

### BRIEF DESCRIPTION OF THE DRAWINGS

Exemplary embodiment(s) of the present invention will be described in detail based on the following figures, wherein:

FIG. 1 is a schematic configuration diagram of a blockchain control system according to the present exemplary embodiment;

FIG. 2 is a schematic configuration diagram of an image processing device according to the present exemplary embodiment;

FIG. 3 is a conceptual diagram showing a structure of a blockchain;

FIG. 4 is a conceptual diagram showing a content of a header of a block;

FIG. 5 is a conceptual diagram showing a content of transaction information;

FIG. 6 is a first flowchart showing a flow of a process of the image processing device according to the present exemplary embodiment; and

FIG. 7 is a second flowchart showing a flow of a process of the image processing device according to the present exemplary embodiment.

### DETAILED DESCRIPTION

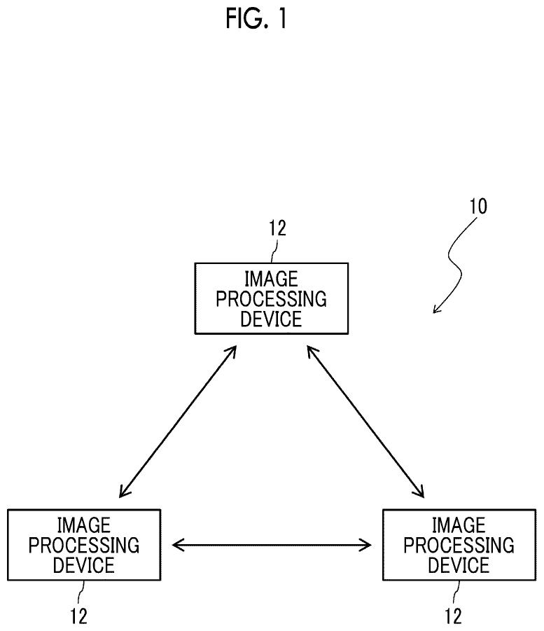

FIG. 1 is a schematic configuration diagram of a blockchain control system 10 according to the present exemplary embodiment. The blockchain control system 10 includes a plurality of devices that are a plurality of nodes of a blockchain. In the present exemplary embodiment, the blockchain control system 10 is configured with a plurality of image processing devices 12 as the plurality of nodes of the blockchain. In the present specification, the image processing device 12 provided in the blockchain control system 10 will be simply referred to as the image processing device 12. The image processing device 12 is a device having a print function, a copy function, a scan function, a FAX function, and the like, and is, for example, a multifunction peripheral. It should be noted that, although only three image processing devices 12 configuring the blockchain control system 10 are shown in FIG. 1, the blockchain control system 10 may include three or more image processing devices 12.

The image processing devices 12 are communicably connected to each other by peer to peer (P2P) via a communication line such as a local area network (LAN) or a wide area network (WAN). The P2P is a communication method in which devices directly communicate with each other without using a server.

In the blockchain control system 10 according to the present exemplary embodiment, billing data formed in each image processing device 12 is managed with the blockchain, so that the loss of the billing data or the tampering with the billing data is suppressed. The billing data is data indicating a process content of the image processing device 12. For example, the billing data formed in a case where the image processing device 12 executes a print process includes information such as the number of printed sheets, an output paper size, and color print/monochrome print. The billing data is used, for example, in a case where a billing amount to be billed to a user who uses the image processing device 12 is decided.

Although details will be described later, the blockchain is a form of a distributed database in which a plurality of blocks are connected to each other. The distributed database here refers to that an identical content of the blockchain is stored in each of the image processing devices 12. Each block configuring the blockchain includes one or more pieces of the transaction information that is a management target. In the present exemplary embodiment, each transaction information is billing data. In addition, each block includes a hash value of block information of an immediately previous block that is a block added to the blockchain last time (hereinafter, referred to as a hash value of the block for convenience). The block information is information including the transaction information included in the block. The hash value is a value obtained by irreversibly converting target data (here, the block information of the immediately previous block). Therefore, in a case where the transaction information included in a certain block is lost or tampered with, the hash value included in all subsequent blocks is different from the normal hash value. With such a mechanism, the loss of the transaction information or the tampering with the transaction information (billing data in the present exemplary embodiment) is suppressed.

In a case where the block can be easily added to the blockchain, a malicious user can easily add an unauthorized block (for example, a block including tampered transaction information) to the blockchain. Therefore, in the blockchain, it is common that a constraint for adding a new block is provided. One such constraint is an algorithm called proof of work (PoW). The PoW is a mechanism in which a processor of the node (in the present exemplary embodiment, the image processing device 12) of the blockchain repeats a calculation, and in a case where a calculation result satisfies a predetermined condition, a new block is permitted to be added to the blockchain. In the blockchain according to the present exemplary embodiment, the PoW is also used as a constraint for adding a new block.

A process of adding a new block to the blockchain is called a mining process. In the mining process by the PoW, the processor of the node calculates the hash value of the block by inputting a combination value obtained by combining the block information of the latest block added to the blockchain, that is, one or more pieces of the transaction information included in the block, the hash value of the immediately previous block of the block, and a value called a nonce, to a hash function. As the hash function, for example, a function such as SHA-256 is used. In a case where the calculated hash value is smaller than a predetermined threshold value (referred to as a difficulty target), the mining process is successful, and a new block is permitted to be added to the blockchain. The hash value smaller than the threshold value is referred to as a correct answer hash value. In a case where the calculated hash value is equal to or larger than the threshold value, the processor changes the value of the nonce and recalculates the hash value. It should be noted that, due to the characteristics of the hash function, the output hash value greatly changes in a case where the input data (here, the value of the nonce) is slightly different. As described above, the processor repeatedly calculates the hash value while changing the value of the nonce until the hash value is smaller than the threshold value (in other words, until the correct answer hash value is obtained). Generally, the amount of calculation required to obtain the correct answer hash value is huge.

In the present specification, the difficulty of the mining process (referred to as difficulty) is referred to as mining difficulty. In the case of the PoW, the mining difficulty can be adjusted by the threshold value described above. That is, it is more difficult to succeed in the mining process as the value of the threshold value is smaller, and it is easier to succeed in the mining process as the value of the threshold value is larger.

As described above, a huge amount of calculation is required to succeed in the mining process. Therefore, it is proposed to execute the mining process in cooperation with the plurality of nodes. A group of nodes that execute the mining process in cooperation with each other is called a mining pool. In the present exemplary embodiment, the plurality of image processing devices 12 form the mining pool, and the plurality of image processing devices 12 (more specifically, the processors) cooperate with each other to execute the mining process.

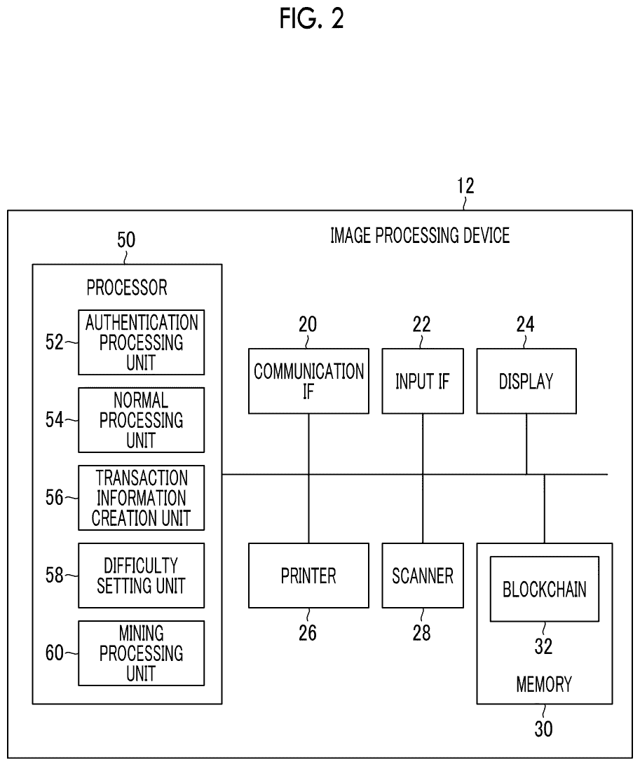

FIG. 2 is a schematic configuration diagram of the image processing device 12. The image processing device 12 is a device that executes the mining process and a normal process (process other than the mining process as described above). The normal process in the image processing device 12 is, for example, the print process, a scan process, a copy process, a FAX process, and the like. Since the image processing devices 12 provided in the blockchain control system 10 have the same configuration as each other, one image processing device 12 will be described here.

The communication interface (IF) 20 is configured with, for example, a network adapter or the like. The communication IF 20 exhibits a function of communicating with another device via a communication line. In particular, in the present exemplary embodiment, the communication IF 20 exhibits a function of communicating with the other image processing devices 12 by the P2P.

An input IF 22 is configured with, for example, a button or a touch panel. The input IF 22 is used in a case where the user inputs an instruction to the image processing device 12.

A display 24 is configured with, for example, a liquid crystal display, an organic electro luminescent (EL) display or the like. Various screens are displayed on the display 24 in response to an instruction from a processor 50 described later.

A printer 26 is, for example, a laser printer or an inkjet printer, and is a mechanism that executes the print process of forming an image on a print medium such as paper based on an input print job. In a case where the printer 26 is a laser printer, the printer 26 is configured with, for example, a photosensitive drum, a charging roller, a transfer roller, a fixing roller, a toner, and the like. In a case where the printer 26 is an inkjet printer, the printer 26 is configured with nozzles, a charging electrode plate, a deflection electrode plate, ink, and the like.

A scanner 28 is configured with a light source, an image sensor such as a charge-coupled device (CCD), or the like. The scanner 28 is a mechanism that executes the scan process of optically reading a paper medium to acquire image data.

The memory 30 includes a hard disk drive (HDD), a solid state drive (SSD), an embedded multimedia card (eMMC), a read only memory (ROM), a random access memory (RAM), and the like. The memory 30 stores a blockchain control program for operating each unit of the image processing device 12. It should be noted that the blockchain control program can be stored in, for example, a computer readable non-transitory storage medium such as a universal serial bus (USB) memory or an SD card. The image processing device 12 can read and execute the blockchain control program from such a storage medium. As shown in FIG. 2, the memory 30 stores a blockchain 32.

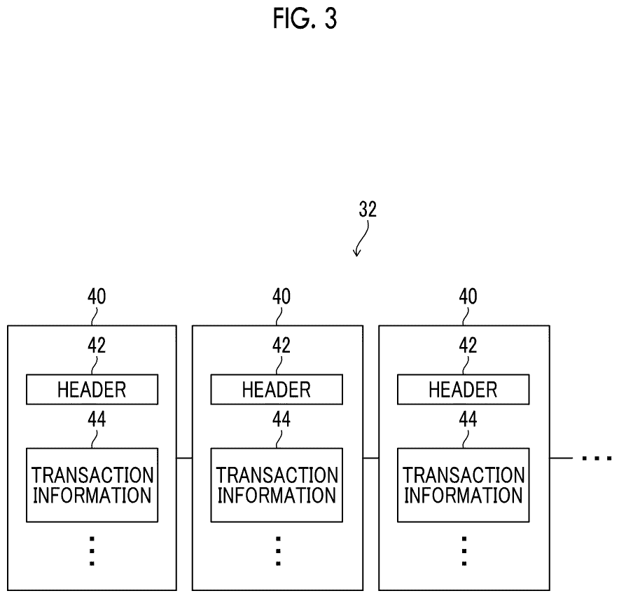

FIG. 3 is a conceptual diagram showing a structure of the blockchain 32. As described above, the blockchain 32 has a structure in which a plurality of blocks 40 are connected. Each block 40 includes a header 42 and transaction information 44.

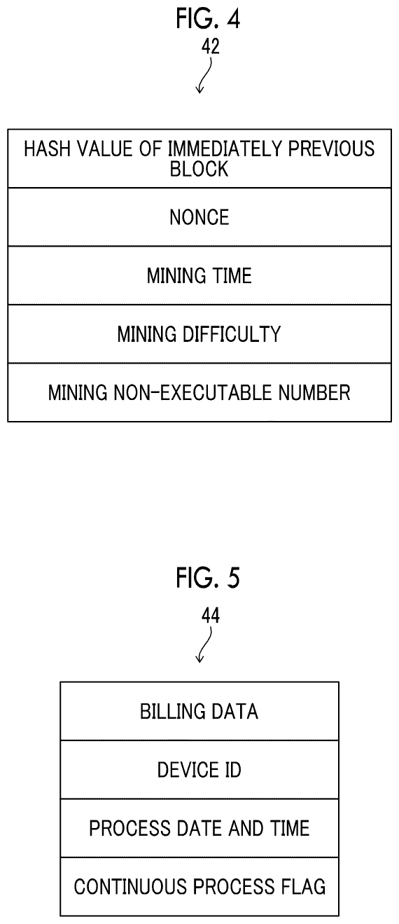

FIG. 4 is a conceptual diagram showing a content of the header 42 included in each block 40. As shown in FIG. 4, in the present exemplary embodiment, the header 42 includes information indicating the hash value, the nonce, and the mining time of the immediately previous block 40, information indicating the mining difficulty, and a mining non-executable number. The hash value of the immediately previous block 40 is the correct answer hash value calculated in a case where the immediately previous block 40 is added to the blockchain 32. The nonce is a nonce used in a case where the correct answer hash value of the block 40 is calculated. The mining time is a time required for the mining process for the block 40. In other words, the mining time is a time required from the start of the mining process of the block 40 to the success of the mining process (that is, the calculation of the correct answer hash value). The mining difficulty is a mining difficulty in a case where the block 40 is added to the blockchain 32. In the present exemplary embodiment, the threshold value in a case where the correct answer hash value is calculated is included in the header 42 as the mining difficulty. The mining non-executable number will be described later.

FIG. 5 is a conceptual diagram showing a content of the transaction information 44 included in each block 40. As shown in FIG. 5, in the present exemplary embodiment, the transaction information 44 includes the billing data, information indicating a device ID, the process date and time, and a continuous process flag. The billing data is the data indicating the process content of the image processing device 12 as described above. The device ID is an identifier for uniquely identifying the image processing device 12 that executes the process related to the billing data. The process date and time is a date and time at which the image processing device 12 completes the process related to the billing data. The continuous process flag has a value of ON or OFF. The continuous process flag will be described later.

With reference to FIG. 2 again, the processor 50 is configured with, for example, a central processing unit (CPU). The processor 50 is communicably connected to the communication IF 20, the input IF 22, the display 24, the printer 26, the scanner 28, and the memory 30 via a data bus. The processor 50 exhibits functions as an authentication processing unit 52, a normal processing unit 54, a transaction information creation unit 56, a difficulty setting unit 58, and a mining processing unit 60 in accordance with the blockchain control program stored in the memory 30.

The authentication processing unit 52, the normal processing unit 54, and the transaction information creation unit 56 are mostly functions related to the creation and transmission of the transaction information 44 included in the block 40.

The authentication processing unit 52 authenticates the user who uses the image processing device 12. For example, the image processing device 12 includes a card reader (not shown), and the authentication processing unit 52 authenticates the user by a user ID obtained by the card reader reading an ID card of the user. The authentication processing unit 52 may authenticate the user by causing the user to input the user ID and a password. A state where the user is authenticated is expressed as the user being logged in to the image processing device 12. In a case where the user terminates the use of the image processing device 12, the user inputs a logout instruction to the image processing device 12 from the input IF 22 or the like. The authentication processing unit 52 cancels the authentication of the user based on the instruction.

The normal processing unit 54 executes control for executing the normal process, based on a job as a process instruction input to the image processing device 12 by the user. For example, the normal processing unit 54 causes the printer 26 to execute the print process in a case where the print job is received from the user. In addition, for example, the normal processing unit 54 causes the scanner 28 to execute the scan process in a case where a scan job is received from the user.

The transaction information creation unit 56 creates the transaction information 44 (see FIG. 5) related to the normal process in a case where the normal process by the control of the normal processing unit 54 is completed. Specifically, the transaction information creation unit 56 creates the billing data related to the normal process based on attribute information of the job related to the normal process. In addition, the transaction information creation unit 56 acquires the device ID of the image processing device 12 (which may be stored in advance in the memory 30) and the process date and time in a case where the process of the job related to the normal process is completed, and includes the device ID and the process date and time in the transaction information 44.

Further, the transaction information creation unit 56 includes the continuous process flag as process execution/non-execution information in the transaction information 44. The continuous process flag is a flag indicating whether or not the image processing device 12 continues the normal process. As described above, although the mining process is executed in the mining pool configured with the plurality of image processing devices 12 that are the plurality of nodes of the blockchain, in the present exemplary embodiment, it is considered that the image processing device 12 during the normal process cannot execute the mining process. That is, the continuous process flag is also information indicating whether or not the mining process can be executed in the image processing device 12.

In the present exemplary embodiment, the transaction information creation unit 56 sets the continuous process flag to ON in a case where at least one of a condition that the user remains logged in to the image processing device 12 after the normal process is completed or a condition that there is a job being executed or a job waiting for execution in the image processing device 12 is satisfied. A case where the continuous process flag is ON refers to that the image processing device 12 cannot execute the mining process. On the other hand, the transaction information creation unit 56 sets the continuous process flag to OFF in a case where both of the condition that the user logs out after the normal process is completed and the condition that there is no job being executed or no job waiting for execution in the image processing device 12 are satisfied. A case where the continuous process flag is OFF refers to that the image processing device 12 can execute the mining process.

The transaction information creation unit 56 simultaneously transmits the created transaction information 44 to the other image processing devices 12 provided in the blockchain control system 10.

In this way, in a case where the normal process is executed in each image processing device 12 provided in the blockchain control system 10, the transaction information 44 is simultaneously transmitted from the image processing device 12 that executes the normal process to the other image processing devices 12. Each image processing device 12 accumulates and stores the transaction information 44 acquired from any of the plurality of image processing devices 12 provided in the blockchain control system 10 (including the image processing device 12), in the memory 30.

The difficulty setting unit 58 and the mining processing unit 60 are functions related to the mining process of the block 40 including the transaction information 44 transmitted from the image processing device 12 or the other image processing devices 12.

The difficulty setting unit 58 sets the mining difficulty related to the current block 40 before the mining processing unit 60 executes the mining process on the current block 40 that is the block 40 to be added to the blockchain 32 in this time.

In the present exemplary embodiment, first, the difficulty setting unit 58 calculates the number of the image processing devices 12 in which the continuous process flag is ON, based on the device ID and the continuous process flag of each transaction information 44 (hereinafter, referred to as the current transaction information 44) included in the current block 40, and uses the calculated number as the mining non-executable number. That is, the mining non-executable number is information indicating the number of the image processing devices 12 determined that the mining process cannot be executed at a point in time at which the mining process of the current block 40 is executed. It should be noted that the transaction information 44 may include a plurality of pieces of transaction information 44 having the identical device ID. For example, there is a case where the identical image processing device 12 processes a plurality of jobs in a short time. In this case, the difficulty setting unit 58 refers to only the continuous process flag included in the transaction information 44 having the latest process date and time among the plurality of pieces of transaction information 44 including the identical device ID. Accordingly, the difficulty setting unit 58 can calculate the mining non-executable number based on the latest state of the image processing device 12 (that is, whether or not the mining process can be executed).

It should be noted that the mining non-executable number included in the header 42 of the block 40 indicates the number of the image processing devices 12 that cannot execute the mining process within the range of the image processing devices 12 related to the current transaction information 44, and may not necessarily indicate the number of the image processing devices 12 that cannot execute the mining process among all the image processing devices 12 provided in the blockchain control system 10. However, in a case where each image processing device 12 executes the process with a certain frequency, it is expected that the transaction information 44 transmitted from a large number of the image processing devices 12 is included in the current transaction information 44, and it is expected that the mining non-executable number calculated by the difficulty setting unit 58 is close to the number of the image processing devices 12 that cannot execute the mining process for the entire blockchain control system 10.

The number of the image processing devices 12 provided in the blockchain control system 10 is not changed so frequently. Therefore, by subtracting the mining non-executable number from the total number of the image processing devices 12 provided in the blockchain control system 10, the number of the image processing devices 12 that can execute the mining process can be obtained. Therefore, the mining non-executable number is also information indicating a mining executable number that is the number of mining executable image processing devices. In addition, the difficulty setting unit 58 may calculate the number of the image processing devices 12 in which the continuous process flag is OFF, based on the device ID and the continuous process flag of each of the current transaction information 44, instead of the mining non-executable number, and may include the mining executable number as number-of-devices information in the header 42.

The difficulty setting unit 58 calculates the mining non-executable number for the block 40 in a case where the block 40 is added to the blockchain 32. Although details will be described later, the mining processing unit 60 includes the mining non-executable number for the block 40 calculated by the difficulty setting unit 58 in the header 42 (see FIG. 4) of the block 40. That is, the header 42 of the immediately previous block 40 described below includes the mining non-executable number indicating the number of the image processing devices 12 determined that the mining process cannot be executed at the point in time at which the mining process is executed of the immediately previous block 40.

Next, the difficulty setting unit 58 refers to the header 42 of the immediately previous block 40 and acquires the mining non-executable number for the immediately previous block 40. Then, the mining non-executable number for the current block 40 is compared with the mining non-executable number for the immediately previous block 40. In a case where the mining non-executable number for the current block 40 is larger than the mining non-executable number for the immediately previous block 40, the difficulty setting unit 58 sets the mining difficulty for the current block 40 to be lower than the mining difficulty for the immediately previous block 40. On the other hand, in a case where the mining non-executable number for the current block 40 is smaller than the mining non-executable number for the immediately previous block 40, the mining difficulty for the current block 40 is set to be higher than the mining difficulty for the immediately previous block 40.

In the present exemplary embodiment, the mining non-executable number for the current block 40 and the mining non-executable number for the immediately previous block 40 are compared to set the mining difficulty, but this assumes that the total number of the image processing devices 12 provided in the blockchain control system 10 does not change greatly. Although the description is repeated, in a case where the total number of the image processing devices 12 provided in the blockchain control system 10 can be grasped, the mining non-executable number is information indicating the mining executable number of the image processing devices 12. As described above, in a case where the mining non-executable number for the current block 40 is larger than the mining non-executable number for the immediately previous block 40, since it can be said that the process capacity of the mining pool in a case of executing the mining process for the current block 40 is smaller than the process capacity of the mining pool in a case of executing the mining process for the immediately previous block 40, the difficulty setting unit 58 sets the mining difficulty for the current block 40 to be lower than the mining difficulty for the immediately previous block 40 in order to suppress the variation in the mining time for the current block 40 with respect to the immediately previous block 40. On the other hand, in a case where the mining non-executable number for the current block 40 is smaller than the mining non-executable number for the immediately previous block 40, since it can be said that the process capacity of the mining pool in a case of executing the mining process for the current block 40 is smaller than the process capacity of the mining pool in a case of executing the mining process for the immediately previous block 40, the difficulty setting unit 58 sets the mining difficulty for the current block 40 to be higher than the mining difficulty for the immediately previous block 40 in order to suppress the variation in the mining time for the current block 40 with respect to the immediately previous block 40. As described above, in a conceptual manner, the difficulty setting unit 58 sets the mining difficulty for the current block 40 based on the comparison between the mining executable number for the current block 40 and the mining executable number for the immediately previous block 40.

In a case where the header 42 includes the mining executable number, the difficulty setting unit 58 sets the mining difficulty for the block 40 for the current block 40 to be lower than the mining difficulty for the immediately previous block 40 in a case where the current mining executable number is smaller than the immediately previous mining executable number, and sets the mining difficulty for the block 40 for the current block 40 to be higher than the mining difficulty for the immediately previous block 40 in a case where the current mining executable number is larger than the immediately previous mining executable number.

In the present exemplary embodiment, the difficulty setting unit 58 sets the mining difficulty for the current block 40 based on the comparison between the mining non-executable number (or mining executable number) for the current block 40 and the mining non-executable number (or mining executable number) for the immediately previous block 40, but the mining difficulty for the current block 40 may be set based on the mining non-executable number (or mining executable number) for the current block 40 without depending on the comparison with the immediately previous block 40. For example, difficulty information indicating a correspondence relationship between the mining non-executable number or the mining executable number and the mining difficulty may be stored in the memory 30 in advance, and the difficulty setting unit 58 may set the mining difficulty for the current block 40 based on the mining non-executable number (or the mining executable number) for the current block 40 and the difficulty information.

Further, the difficulty setting unit 58 may set the mining difficulty for the current block 40 based on the comparison between the mining time indicated by the mining time information included in the header 42 of the immediately previous block 40 added to the blockchain last time and a predetermined reference time. Specifically, in a case where the mining time of the immediately previous block 40 is longer than the reference time, the difficulty setting unit 58 sets the mining difficulty for the current block 40 to be lower than the mining difficulty for the immediately previous block 40. On the other hand, in a case where the mining time of the immediately previous block 40 is shorter than the reference time, the difficulty setting unit 58 sets the mining difficulty for the current block 40 to be higher than the mining difficulty for the immediately previous block 40.

The mining processing unit 60 executes the mining process for the current block 40 including the current transaction information 44 at a predetermined timing (for example, in a case where the number of pieces of the transaction information 44 on which the mining process is not executed and that are accumulated in the memory 30 is a predetermined number, or at a predetermined time interval). As described above, the mining processing unit 60 executes the mining process in cooperation with the mining processing unit 60 of the other image processing devices 12. In particular, in a case where both of the conditions that the user is not logged in to the image processing device 12 and that there is no job being executed or no job waiting for execution in the image processing device 12 are satisfied, that is, in a case where the image processing device 12 can execute the mining process, the mining processing unit 60 executes the mining process. On the contrary, in a case where at least one of the conditions that the user logs in to the image processing device 12 or the job being executed or the job waiting for execution is present in the image processing device 12A is satisfied, that is, in a case where the image processing device 12 is not subject to the mining process, the mining processing unit 60 does not execute the mining process.

The mining process executed by the mining processing unit 60 is as described above. That is, the mining processing unit 60 calculates the hash value of the combination value of one or more pieces of the current transaction information 44, the hash value of the immediately previous block 40, and the nonce. In a case where the hash value as a result of the mining process satisfies a condition that the hash value is smaller than the threshold value set by the difficulty setting unit 58 described later, the mining process is successful. The mining processing unit 60 repeatedly calculates the hash value while changing the nonce until the correct answer hash value is obtained.

In a case where the mining process is successful, the mining processing unit 60 forms the current block 40 including the header 42 (see FIG. 4) and the current transaction information 44 (see FIG. 5). Then, the current block 40 is added to the blockchain 32.

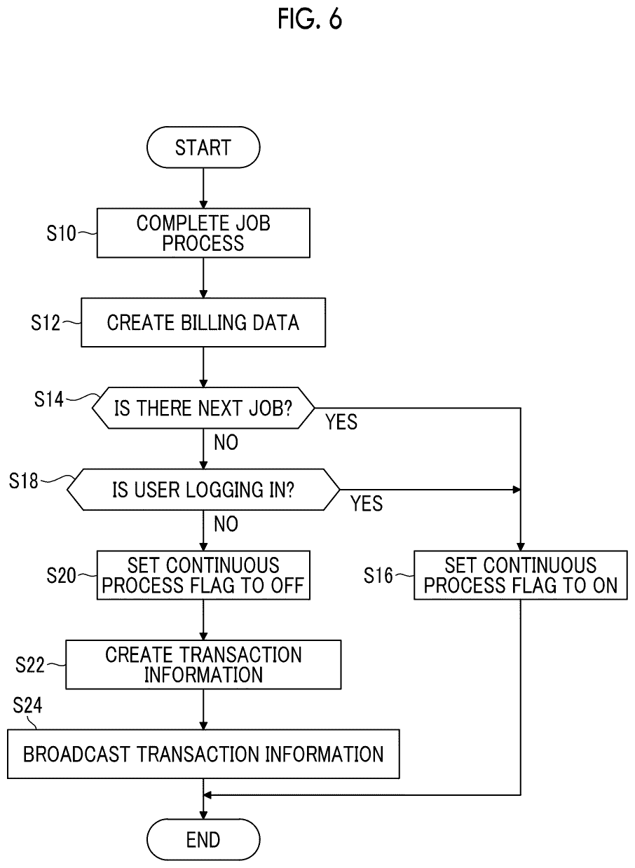

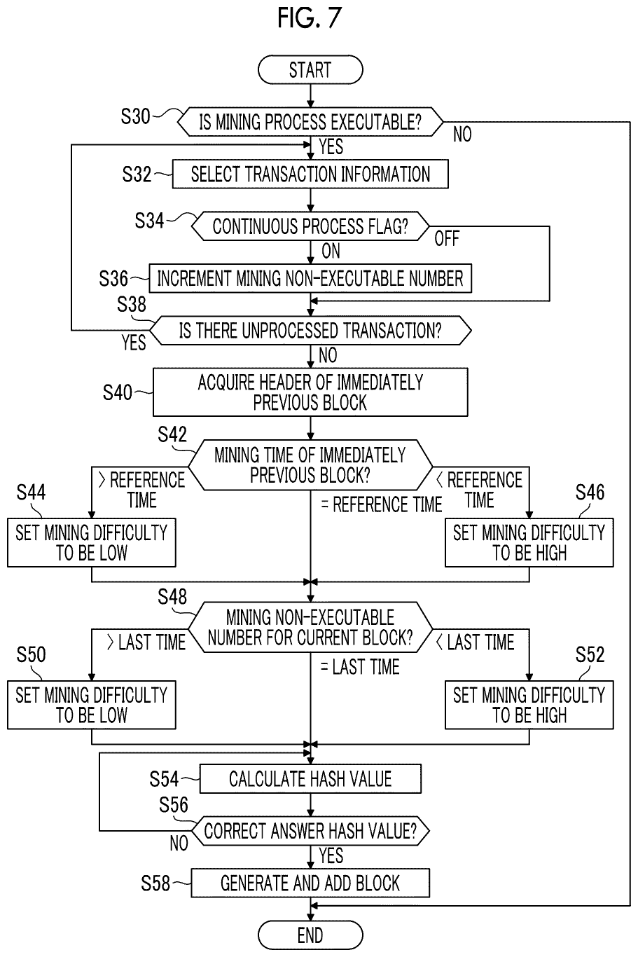

The outline of the blockchain control system 10 according to the present exemplary embodiment is as described above. Hereinafter, a flow of a process of the image processing device 12 will be described with reference to the flowcharts shown in FIGS. 6 and 7.

FIG. 6 is a flowchart showing a flow of a process in which the image processing device 12 creates and transmits the transaction information 44.

In step S10, the normal processing unit 54 executes control for executing the normal process that is the process related to the job in accordance with the job input from the user, and completes the process.

In step S12, the transaction information creation unit 56 creates the billing data related to the normal process processed in step S10, based on the attribute information of the job and the like for which the execution is completed in step S10.

In step S14, the transaction information creation unit 56 determines whether or not there is the normal process being executed or the normal process waiting for execution in the image processing device 12 that is the device of the transaction information creation unit 56. In a case where there is the normal process being executed or the normal process waiting for execution, the process proceeds to step S16, and in step S16, the transaction information creation unit 56 sets the continuous process flag to ON. In a case where there is no normal process being executed or no normal process waiting for execution, the process proceeds to step S18.

In step S18, the transaction information creation unit 56 determines whether or not the user logs in to the image processing device 12. The process proceeds to step S18 in a case where the user logs in, and the process proceeds to step S20 in a case where the user does not log in.

In step S20, the transaction information creation unit 56 sets the continuous process flag to OFF.

In step S22, the transaction information creation unit 56 creates the transaction information 44 including the billing data created in step S12, the device ID of the image processing device 12, the completion date and time of the normal process in step S10, and the continuous process flag set in step S16 or S18.

In step S24, the transaction information creation unit 56 simultaneously transmits the transaction information 44 created in step S22 to the other image processing devices 12 provided in the blockchain control system 10.

FIG. 7 is a flowchart showing a flow of a setting process of the mining difficulty by the difficulty setting unit 58 and the mining process for the current block 40 by the mining processing unit 60.

In step S30, the mining processing unit 60 determines whether or not the image processing device 12 can execute the mining process. That is, the mining processing unit 60 determines that the mining process can be executed in a case where both of the condition that the user does not log in to the image processing device 12 and the condition that there is no job being executed or no job waiting for execution in the image processing device 12 are satisfied, and determines that the mining process cannot be executed in a case where at least one of the condition that the user remains logged in to the image processing device 12 or the condition that there is the job being executed or the job waiting for execution in the image processing device 12 is satisfied. In a case where the image processing device 12 cannot execute the mining process, the process is terminated. In a case where the image processing device 12 can execute the mining process, the process proceeds to step S32.

In step S32, the difficulty setting unit 58 selects one of the transaction information 44 on which the mining process is not executed and which is stored in the memory 30.

In step S34, the difficulty setting unit 58 checks the continuous process flag of the transaction information 44 selected in step S32. In a case where the continuous process flag is ON, the process proceeds to step S36. In a case where the continuous process flag is OFF, the process bypasses step S36 and proceeds to step S38.

In step S36, the difficulty setting unit 58 increments (that is, increases by 1) the mining non-executable number for the current block 40.

In step S38, the difficulty setting unit 58 determines whether or not unprocessed transaction information 44 on which the mining process is not executed remains. In a case where the unprocessed transaction information 44 remains, the process returns to step S32, and in step S32 again, the difficulty setting unit 58 selects the unprocessed transaction information 44 and then repeats the processes of steps S34 to S36. In the processes of steps S32 to S38, the mining non-executable number for the current block 40 is calculated. In a case where the unprocessed transaction information 44 does not remain, the process proceeds to step S40.

In step S40, the difficulty setting unit 58 acquires the header 42 of the immediately previous block 40. In particular, the difficulty setting unit 58 acquires the mining time and the mining non-executable number for the immediately previous block 40.

In step S42, the difficulty setting unit 58 compares the mining time of the immediately previous block 40 acquired in step S40 with the predetermined reference time. In a case where the mining time of the immediately previous block 40 is longer than the reference time, the process proceeds to step S44, and the difficulty setting unit 58 sets the mining difficulty for the current block 40 to be lower than the mining difficulty for the immediately previous block 40. In a case where the mining time of the immediately previous block 40 is shorter than the reference time, the process proceeds to step S46, and the difficulty setting unit 58 sets the mining difficulty for the current block 40 to be higher than the mining difficulty for the immediately previous block 40. In a case where the mining time of the immediately previous block 40 is the same as the reference time, the process proceeds to step S48.

In step S48, the difficulty setting unit 58 compares the mining non-executable number for the current block 40 calculated in steps S32 to S38 with the mining non-executable number for the immediately previous block 40 acquired in step S40. In a case where the mining non-executable number for the current block 40 is larger than the mining non-executable number for the immediately previous block 40, the process proceeds to step S50, and the difficulty setting unit 58 sets the mining difficulty for the current block 40 to be lower than the mining difficulty for the immediately previous block 40. In a case where the mining non-executable number for the current block 40 is smaller than the mining non-executable number for the immediately previous block 40, the process proceeds to step S52, and the difficulty setting unit 58 sets the mining difficulty for the current block 40 to be higher than the mining difficulty for the immediately previous block 40. In a case where the mining non-executable number for the current block 40 is the same as the mining non-executable number for the immediately previous block 40, the process proceeds to step S54.

In the processes of steps S40 to S52, the mining difficulty for the current block 40 is set. In the present exemplary embodiment, the threshold value in the POW as the mining difficulty is set.

In step S54, the mining processing unit 60 calculates the hash value of the combination value of the current transaction information 44, the hash value of the immediately previous block 40, and the nonce.

In step S56, the mining processing unit 60 determines whether or not the hash value calculated in step S54 is the correct answer hash value, that is, whether or not the hash value calculated in step S54 is smaller than the threshold value set in steps S40 to S52. In a case where the hash value calculated in step S54 is not the correct answer hash value, the process returns to step S54, and the mining processing unit 60 changes the nonce and recalculates the hash value. In a case where the hash value calculated in step S54 is the correct answer hash value, the process proceeds to step S58.

In step S58, the mining processing unit 60 forms the current block 40 including the header 42 and the current transaction information 44. Then, the current block 40 is added to the blockchain 32.

Although the exemplary embodiment of the present invention has been described above, the present invention is not limited to the exemplary embodiment and can be subjected to various changes without departing from the gist of the present invention.

For example, in the present exemplary embodiment, the blockchain control system 10 is configured, the image processing device 12 is a device that stores the blockchain 32, and the data managed with the blockchain 32 is the billing data. However, the device configuring the blockchain control system 10 may be another device. The data managed with the blockchain 32 may be data other than the billing data.

In addition, in the present exemplary embodiment, each image processing device 12 includes the continuous process flag as the process execution/non-execution information indicating whether or not the mining process can be executed in the image processing device 12 in the transaction information 44, and then simultaneously transmits the transaction information 44 to the other image processing devices 12. Accordingly, each image processing device 12 outputs the process execution/non-execution information. However, the image processing device 12 may not necessarily include the process execution/non-execution information in the transaction information 44, and may output the process execution/non-execution information by another method. For example, each image processing device 12 may intermittently transmit the process execution/non-execution information to a predetermined server. Thereafter, in a case where the mining process of the current block 40 is executed, the difficulty setting unit 58 may acquire the number of the image processing devices 12 that can execute the mining process for the current block 40, based on the process execution/non-execution information transmitted from each image processing device 12 and stored in the server. By including the process execution/non-execution information in the transaction information 44, it is not necessary to separately prepare a server that stores the process execution/non-execution information, and each image processing device 12 can acquire the process execution/non-execution information within a framework of the blockchain 32.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

A blockchain control system comprising:
a plurality of devices that each store a blockchain, are communicably connected to each other, and each execute a mining process of adding a new block to the blockchain in cooperation with another device; and
a processor,
wherein each device included in the plurality of devices outputs process execution/non-execution information indicating whether or not the mining process is executable in the device, and
the processor is configured to:
   acquire transaction information that is information included in a block from any of the plurality of devices;
   set a mining difficulty that is a difficulty of the mining process regarding the block including the transaction information in accordance with the number of process executable devices that are devices determined that the mining process is executable at a point in time at which the mining process of the block including the transaction information is executed among the plurality of devices, based on the process execution/non-execution information output by each device; and
   add the block including the transaction information to the blockchain in a case where a result of the mining process by the process executable device satisfies a condition decided in accordance with the mining difficulty.

(((2)))

The blockchain control system according to (((1))),
wherein each device included in the plurality of devices transmits the transaction information to the plurality of devices in a case where a normal process that is a process other than the mining process is completed, and
the process execution/non-execution information regarding the device included in the plurality of devices is included in the transaction information transmitted from the device.

(((3)))

The blockchain control system according to (((2))),
wherein each device included in the plurality of devices transmits the transaction information including the process execution/non-execution information indicating that the mining process is not executable to the plurality of devices in a case where a user remains logged in to the device after the normal process is completed or in a case where there is another normal process being executed or another normal process waiting for execution in the device.

(((4)))

The blockchain control system according to (((2))) or (((3))
wherein each device included in the plurality of devices includes number-of-devices information indicating the number of the process executable devices in a header of a block based on the process execution/non-execution information included in one or more pieces of the transaction information included in the block, and
the processor is configured to:
   set the mining difficulty based on a comparison between the number-of-devices information included in a header of an immediately previous block added to the blockchain last time, and the number of the process executable devices calculated from the process execution/non-execution information included in one or more pieces of the transaction information included in a current block to be added to the blockchain this time.

(((5)

The blockchain control system according to any one of (((1))) to (4)
wherein each device included in the plurality of devices includes mining time information indicating a mining time required for the mining process of a block in a header of the block, and
the processor is configured to:
   set the mining difficulty based on a comparison between the mining time indicated by the mining time information included in a header of an immediately previous block added to the blockchain last time, and a predetermined reference time.

(((6))

The blockchain control system according to any one of (((1))) to ((5))
wherein each device included in the plurality of devices is an image processing device, and
the transaction information includes information indicating a content of a process executed by the image processing device.

(((7)))

A blockchain control program for causing a computer to execute a process comprising:
acquiring transaction information that is information included in a block from any of a plurality of devices that each store a blockchain, are communicably connected to each other, and each execute a mining process of adding a new block to the blockchain in cooperation with another device;
setting a mining difficulty that is a difficulty of the mining process regarding the block including the transaction information in accordance with the number of process executable devices that are devices determined that the mining process is executable at a point in time at which the mining process of the block including the transaction information is executed among the plurality of devices, based on process execution/non-execution information that is output by each device included in the plurality of devices and indicates whether or not the mining process is executable in the device; and
adding the block including the transaction information to the blockchain in a case where a result of the mining process by the process executable device satisfies a condition decided in accordance with the mining difficulty.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A blockchain control system comprising:
a plurality of devices that each store a blockchain, are communicably connected to each other, and each execute a mining process of adding a new block to the blockchain in cooperation with another device; and
a processor,
wherein each device included in the plurality of devices outputs process execution/non-execution information indicating whether or not the mining process is executable in the device, and
the processor is configured to:
acquire transaction information that is information included in a block from any of the plurality of devices;
set a mining difficulty that is a difficulty of the mining process regarding the block including the transaction information in accordance with the number of process executable devices that are devices determined that the mining process is executable at a point in time at which the mining process of the block including the transaction information is executed among the plurality of devices, based on the process execution/non-execution information output by each device; and
add the block including the transaction information to the blockchain in a case where a result of the mining process by the process executable device satisfies a condition decided in accordance with the mining difficulty.

2. The blockchain control system according to claim 1,
wherein each device included in the plurality of devices transmits the transaction information to the plurality of devices in a case where a normal process that is a process other than the mining process is completed, and
the process execution/non-execution information regarding the device included in the plurality of devices is included in the transaction information transmitted from the device.

3. The blockchain control system according to claim 2,
wherein each device included in the plurality of devices transmits the transaction information including the process execution/non-execution information indicating that the mining process is not executable to the plurality of devices in a case where a user remains logged in to the device after the normal process is completed or in a case where there is another normal process being executed or another normal process waiting for execution in the device.

4. The blockchain control system according to claim 2,
wherein each device included in the plurality of devices includes number-of-devices information indicating the number of the process executable devices in a header of a block based on the process execution/non-execution information included in one or more pieces of the transaction information included in the block, and
the processor is configured to:
set the mining difficulty based on a comparison between the number-of-devices information included in a header of an immediately previous block added to the blockchain last time, and the number of the process executable devices calculated from the process execution/non-execution information included in one or more pieces of the transaction information included in a current block to be added to the blockchain this time.

5. The blockchain control system according to claim 3,
wherein each device included in the plurality of devices includes number-of-devices information indicating the number of the process executable devices in a header of a block based on the process execution/non-execution information included in one or more pieces of the transaction information included in the block, and
the processor is configured to:
set the mining difficulty based on a comparison between the number-of-devices information included in a header of an immediately previous block added to the blockchain last time, and the number of the process executable devices calculated from the process execution/non-execution information included in one or more pieces of the transaction information included in a current block to be added to the blockchain this time.

6. The blockchain control system according to claim 1,
wherein each device included in the plurality of devices includes mining time information indicating a mining time required for the mining process of a block in a header of the block, and
the processor is configured to:
set the mining difficulty based on a comparison between the mining time indicated by the mining time information included in a header of an immediately previous block added to the blockchain last time, and a predetermined reference time.

7. The blockchain control system according to claim 1,
wherein each device included in the plurality of devices is an image processing device, and
the transaction information includes information indicating a content of a process executed by the image processing device.

8. A non-transitory computer readable medium storing a blockchain control program for causing a computer to execute a process comprising:
acquiring transaction information that is information included in a block from any of a plurality of devices that each store a blockchain, are communicably connected to each other, and each execute a mining process of adding a new block to the blockchain in cooperation with another device;
setting a mining difficulty that is a difficulty of the mining process regarding the block including the transaction information in accordance with the number of process executable devices that are devices determined that the mining process is executable at a point in time at which the mining process of the block including the transaction information is executed among the plurality of devices, based on process execution/non-execution information that is output by each device included in the plurality of devices and indicates whether or not the mining process is executable in the device; and
adding the block including the transaction information to the blockchain in a case where a result of the mining process by the process executable device satisfies a condition decided in accordance with the mining difficulty.

9. A blockchain control method comprising:
acquiring transaction information that is information included in a block from any of a plurality of devices that each store a blockchain, are communicably connected to each other, and each execute a mining process of adding a new block to the blockchain in cooperation with another device;
setting a mining difficulty that is a difficulty of the mining process regarding the block including the transaction information in accordance with the number of process executable devices that are devices determined that the mining process is executable at a point in time at which the mining process of the block including the transaction information is executed among the plurality of devices, based on process execution/non-execution information that is output by each device included in the plurality of devices and indicates whether or not the mining process is executable in the device; and
adding the block including the transaction information to the blockchain in a case where a result of the mining process by the process executable device satisfies a condition decided in accordance with the mining difficulty.
